(19) United States
(12) Patent Application Publication
(10) Pub. No.: US 2013/0107802 A1
(43) Pub. Date: May 2, 2013

(54) DOWNLINK TIME DIFFERENCE DETERMINATION IN FRAME ASYNCHRONOUS SYSTEMS

(71) Applicant: QUALCOMM INCORPORATED, San Diego, CA (US)

(72) Inventors: Kuo-Chun Lee, San Diego, CA (US); Tom Chin, San Diego, CA (US); Guangming Shi, San Diego, CA (US); Steven D. Cheng, San Diego, CA (US)

(73) Assignee: QUALCOMM INCORPORATED, San Diego, CA (US)

(21) Appl. No.: 13/654,370

(22) Filed: Oct. 17, 2012

Related U.S. Application Data
(60) Provisional application No. 61/551,868, filed on Oct. 26, 2011.

(51) Int. Cl. H04W 4/00

(52) U.S. Cl. 370/328

(57) ABSTRACT

When a user terminal is communicating with asynchronous systems, it may calculate the propagation delay of received signals using the frame offset from the asynchronous base stations. The user terminal may calculate a time difference between a frame reference of a first base station and a second base station and use the time difference to determine a propagation time difference.

### CROSS-REFERENCE TO RELATED APPLICATION

This application claims the benefit under 35 U.S.C. §119(e) to U.S. Provisional Patent Application No. 61/551,868 entitled “DOWNLINK TIME DIFFERENCE DETERMINATION IN FRAME ASYNCHRONOUS SYSTEMS,” filed on Oct. 26, 2011, the disclosure of which is expressly incorporated by reference herein in its entirety.

### BACKGROUND

1. Field

Aspects of the present disclosure relate generally to wireless communication systems, and more particularly to determining a downlink time difference in frame asynchronous systems.

2. Background

Wireless communication networks are widely deployed to provide various communication services such as voice, video, packet data, messaging, broadcast, etc. These wireless networks may be multiple-access networks capable of supporting multiple users by sharing the available network resources. A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

Offered is a method of wireless communication. The method includes receiving a first signal transmitted from a first base station and a second signal transmitted from a second base station, the first signal having a first frame reference, and the second signal having a second frame reference. The method also includes receiving a first time of transmission of the first frame reference of the first base station and receiving a second time of transmission of the second frame reference of the second base station. The method further includes determining a reception time difference between the first frame reference and the second frame reference. The method still further includes determining a propagation time difference from the determined reception time difference and from the received first and second times of transmission.

Offered is an apparatus for wireless communication. The apparatus includes means for receiving a first signal transmitted from a first base station and a second signal transmitted from a second base station, the first signal having a first frame reference, and the second signal having a second frame reference. The apparatus also includes means for receiving a first time of transmission of the first frame reference of the first base station and means for receiving a second time of transmission of the second frame reference of the second base station. The apparatus further includes means for determining a reception time difference between the first frame reference and the second frame reference. The apparatus still further includes means for determining a propagation time difference from the determined reception time difference and from the received first and second times of transmission.

Offered is a computer program product for wireless communication in a wireless network. The non-transitory computer-readable medium includes non-transitory program code recorded thereon. The program code includes program code to receive a first signal transmitted from a first base station and a second signal transmitted from a second base station, the first signal having a first frame reference, and the second signal having a second frame reference. The program code also includes program code to receive a first time of transmission of the first frame reference of the first base station and program code to receive a second time of transmission of the second frame reference of the second base station. The program code further includes program code to determine a reception time difference between the first frame reference and the second frame reference. The program code still further includes program code to determine a propagation time difference from the determined reception time difference and from the received first and second times of transmission.

Offered is an apparatus for wireless communication. The apparatus includes a memory and a processor(s) coupled to the memory. The processor(s) is configured to receive a first signal transmitted from a first base station and a second signal transmitted from a second base station, the first signal having a first frame reference, and the second signal having a second frame reference. The processor(s) is also configured to receive a first time of transmission of the first frame reference of the first base station and to receive a second time of transmission of the second frame reference of the second base station. The processor(s) is further configured to determine a reception time difference between the first frame reference and the second frame reference. The processor(s) is still further configured to determine a propagation time difference from the determined reception time difference and from the received first and second times of transmission.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a wireless telecommunications system.

FIG. 2 is a diagram conceptually illustrating various components that may be utilized in a wireless device in accordance with certain aspects of the present disclosure.

FIG. 3 is a block diagram conceptually illustrating an example transmitter and an example receiver that may be used within a wireless communication system that utilizes orthogonal frequency-division multiplexing and orthogonal frequency division multiple access (OFDM/OFDMA) technology, in accordance with certain aspects of the present disclosure.

FIG. 4 is a diagram illustrating frame asynchronous communications according to one aspect of the present disclosure.

FIG. 5 is a diagram illustrating determining a receive time difference according to one aspect of the present disclosure.

FIG. 6A is a diagram illustrating determining a frame offset according to one aspect of the present disclosure.

FIG. 6B is a diagram illustrating determining a frame offset according to one aspect of the present disclosure.

FIG. 7 is a block diagram illustrating a method for determining a downlink time difference according to one aspect of the present disclosure.

FIG. 8 is a block diagram illustrating components for determining a downlink time difference according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The methods and apparatus of the present disclosure may be utilized in a wireless communication system. As used herein, the term “wireless communication” generally refers to technology that may provide any combination of wireless services, such as voice, Internet and/or data network access over a given area. The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for WiMAX and use such WiMAX terminology in much of the description below. The present disclosure is not limited to WiMAX and is contemplated to operate with any frame asynchronous wireless technology, such as LTE.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of multiple parallel subchannels. OFDMA is a multiple access technique in which users are assigned subcarriers in different time slots. OFDMA is a flexible multiple-access technique that can accommodate many users with widely varying applications, data rates and quality of service requirements. OFDM/OFDMA modulation schemes can provide many advantages such as modulation efficiency, spectrum efficiency, flexibility and strong multipath immunity over conventional single carrier modulation schemes.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

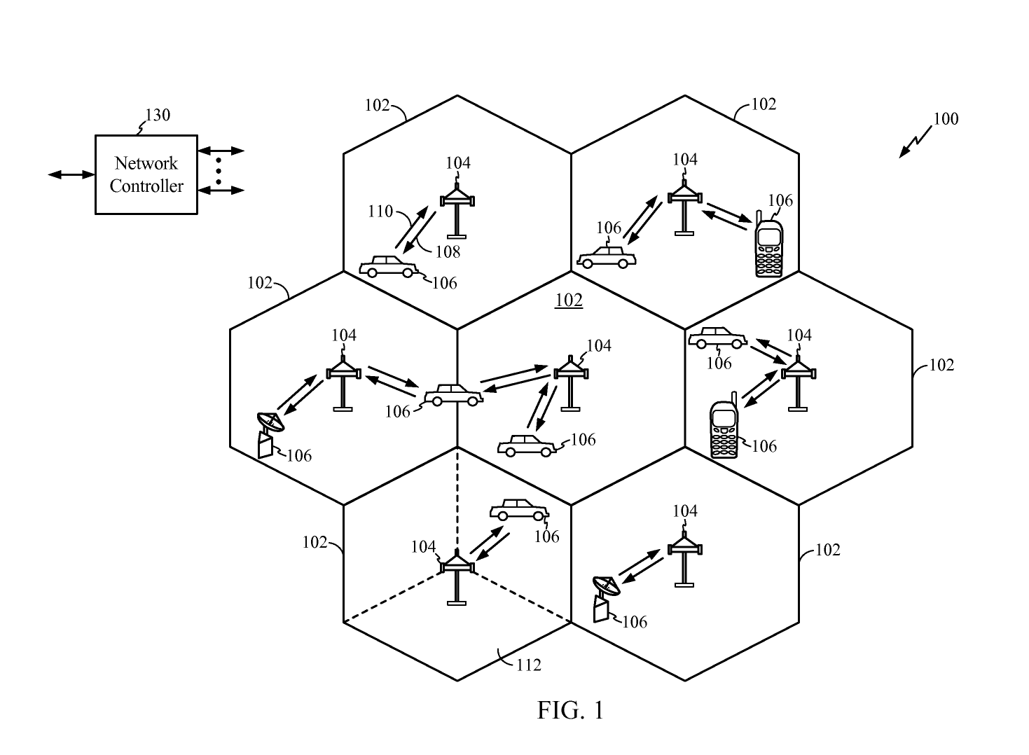

FIG. 1 illustrates an example of a wireless communication system 100 in which aspects of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, an eNodeB or some other terminology. A network controller 130 may couple to a set of base stations 104 and provide coordination and control for these base stations 104. The network controller 130 may communicate with the base stations 104 via a backhaul. The base stations 104 may also communicate with one another, e.g., directly or indirectly via a wireless backhaul or a wireline backhaul.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, cordless phones, personal digital assistants (PDAs), handheld devices, wireless modems, laptop computers, personal computers, wireless communication devices, wireless local loop (WLL) stations, tablet computers, or the like.

A variety of methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

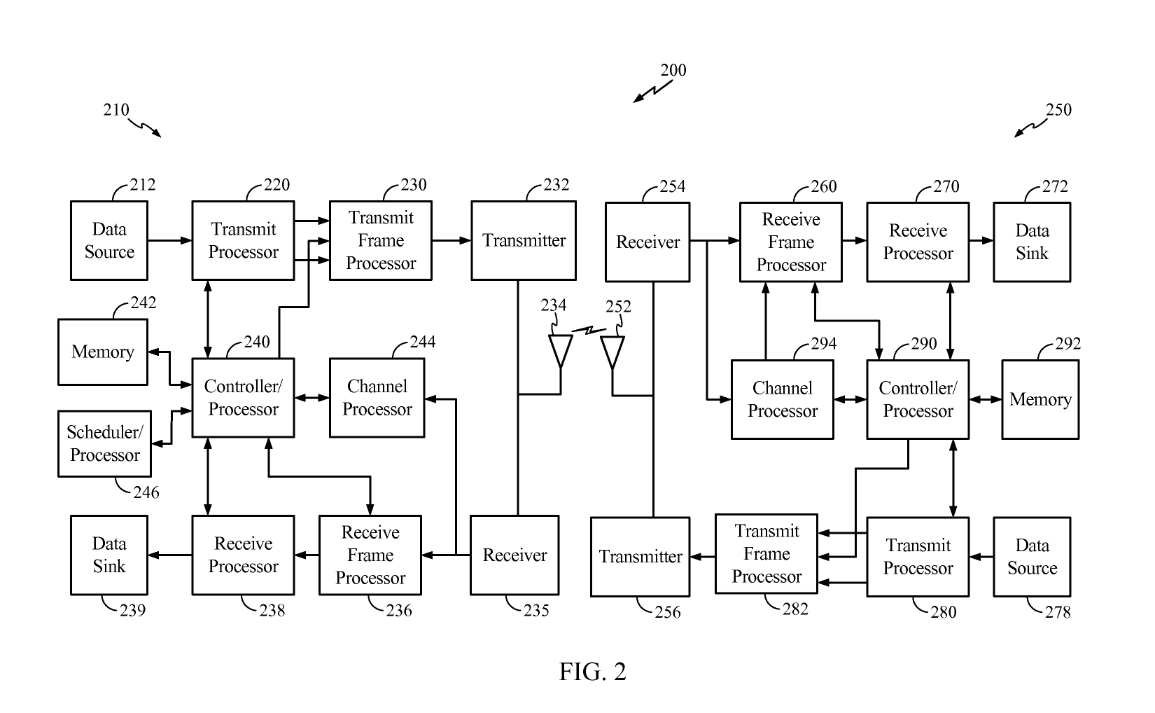

FIG. 2 is a block diagram of a base station 210 in communication with a user terminal 250 in a wireless communication network 200, where the wireless communication network 200 may be the wireless communication network 100 in FIG. 1, the base station 210 may be the base station 104 in FIG. 1, and the user terminal 250 may be the user terminal 106 in FIG. 1. In the downlink communication, a transmit processor 220 may receive data from a data source 212 and control signals from a controller/processor 240. The transmit processor 220 provides various signal processing functions for the data and control signals, as well as reference signals (e.g., pilot signals). For example, the transmit processor 220 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 244 may be used by a controller/processor 240 to determine the coding, modulation, spreading, and/or scrambling schemes for the transmit processor 220. These channel estimates may be derived from a reference signal transmitted by the user terminal 250 or from feedback from the user terminal 250. The symbols generated by the transmit processor 220 are provided to a transmit frame processor 230 to create a frame structure. The frames are then provided to a transmitter 232, which provides various signal conditioning functions including amplifying, filtering, and modulating the frames onto a carrier for downlink transmission over the wireless medium through smart antennas 234. The smart antennas 234 may be implemented with beam steering bidirectional adaptive antenna arrays or other similar beam technologies.

At the user terminal 250, a receiver 254 receives the downlink transmission through an antenna 252 and processes the transmission to recover the information modulated onto the carrier. The information recovered by the receiver 254 is provided to a receive frame processor 260, which parses each frame, and provides the parsed signal to a channel processor 294 and the data, control, and reference signals to a receive processor 270. The receive processor 270 then performs the inverse of the processing performed by the transmit processor 220 in the base station 210. More specifically, the receive processor 270 descrambles and despreads the symbols, and then determines the most likely signal constellation points transmitted by the base station 210 based on the modulation scheme. These soft decisions may be based on channel estimates computed by the channel processor 294. The soft decisions are then decoded and deinterleaved to recover the data, control, and reference signals. The CRC codes are then checked to determine whether the frames were successfully decoded. The data carried by the successfully decoded frames will then be provided to a data sink 272, which represents applications running in the user terminal 250 and/or various user interfaces (e.g., display). Control signals carried by successfully decoded frames will be provided to a controller/processor 290. When frames are unsuccessfully decoded by the receiver processor 270, the controller/processor 290 may also use an acknowledgement (ACK) and/or negative acknowledgement (NACK) protocol to support retransmission requests for those frames.

In the uplink, data from a data source 278 and control signals from the controller/processor 290 are provided to a transmit processor 280. The data source 278 may represent applications running in the user terminal 250 and various user interfaces (e.g., keyboard). Similar to the functionality described in connection with the downlink transmission by the base station 210, the transmit processor 280 provides various signal processing functions including CRC codes, coding and interleaving to facilitate FEC, mapping to signal constellations, spreading with OVSFs, and scrambling to produce a series of symbols. Channel estimates, derived by the channel processor 294 from a reference signal transmitted by the base station 210 or from feedback contained in the midamble transmitted by the base station 210, may be used to select the appropriate coding, modulation, spreading, and/or scrambling schemes. The symbols produced by the transmit processor 280 will be provided to a transmit frame processor 282 to create a frame structure. The frames are then provided to a transmitter 256, which provides various signal conditioning functions including amplification, filtering, and modulating the frames onto a carrier for uplink transmission over the wireless medium through the antenna 252. The receiver 254 and transmitter 256 may be combined into a transceiver.

The uplink transmission is processed at the base station 210 in a manner similar to that described in connection with the receiver function at the user terminal 250. A receiver 235 receives the uplink transmission through the antenna 234 and processes the transmission to recover the information modulated onto the carrier. The information recovered by the receiver 235 is provided to a receive frame processor 236, which parses each frame, and provides the parsed data to the channel processor 244 and the data, control, and reference signals to a receive processor 238. The receive processor 238 performs the inverse of the processing performed by the transmit processor 280 in the user terminal 250. The data and control signals carried by the successfully decoded frames may then be provided to a data sink 239 and the controller/processor, respectively. If some of the frames were unsuccessfully decoded by the receive processor, the controller/processor 240 may also use an acknowledgement (ACK) and/or negative acknowledgement (NACK) protocol to support retransmission requests for those frames.

The controller/processors 240 and 290 may be used to direct the operation at the base station 210 and the user terminal 250, respectively. For example, the controller/processors 240 and 290 may provide various functions including timing, peripheral interfaces, voltage regulation, power management, and other control functions. The computer readable media of memories 242 and 292 may store data and software for the base station 210 and the user terminal 250, respectively. The memories may include both read-only memory (ROM) and random access memory (RAM), provides instructions and data to the processors. A portion of the memory may also include non-volatile random access memory (NVRAM). The processors typically perform logical and arithmetic operations based on program instructions stored within the memory. The instructions in the memory may be executable to implement the methods described herein. The processors may include one or more digital signal processors (DSPs) for use in processing signals.

A scheduler/processor 246 at the base station 210 may be used to allocate resources to the user terminals and schedule downlink and/or uplink transmissions for the user terminals.

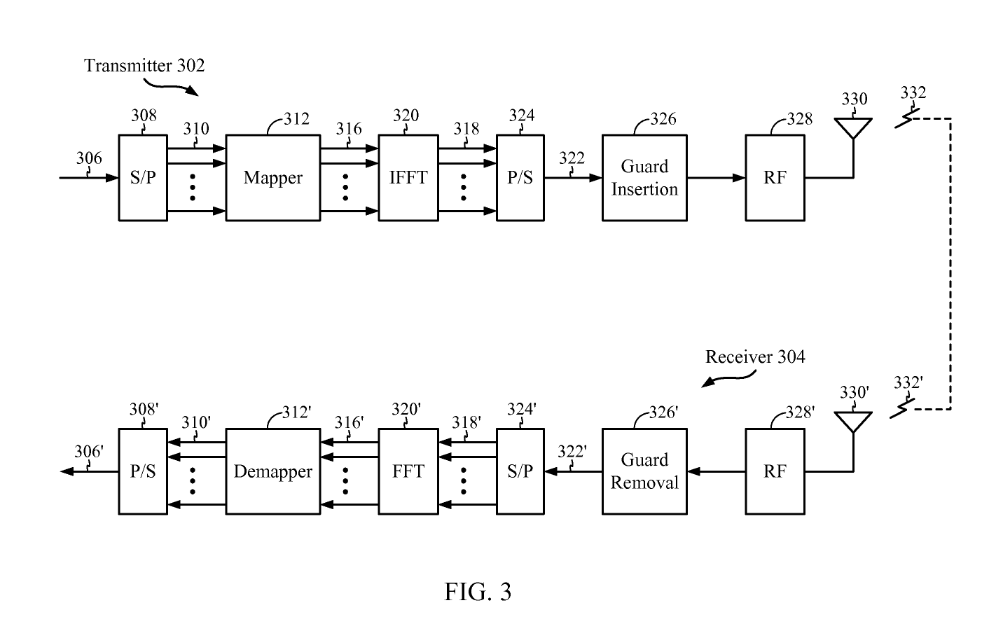

FIG. 3 illustrates an example of a transmitter 302 that may be used within a wireless communication system 100 that utilizes OFDM/OFDMA. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, N.sub.s, is equal to N.sub.cp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor.

In WiMAX systems, base stations may broadcast a location based service advertisement (LBS-ADV) message that includes location information for the transmitting base station and neighbor base stations. The location information may be in absolute position, such as latitude (in degrees), longitude (in degrees), and altitude (in meters). Or, the location information may be in a relative position such as distance north (or south) of a reference point (in meters), distance east (or west) of the reference point (in meters), and distance above (or below) a reference point (in meters). The LBS-ADV message may also include additional information such as frequency accuracy and global positioning system (GPS) time. The location information may be useful for various applications such as location-based services and handover.

With respect to location-based service applications, a user terminal/mobile station may determine its location using several different methods. One method is called Downlink Time Difference of Arrival (D-TDOA). D-TDOA involves the user terminal measuring the time difference of arrival of preamble signals transmitted from multiple base stations and estimating the user terminal location with additional position information from neighboring base stations derived from position information messages, such as LBS-ADV messages.

During handover, a user terminal may measure the relative delay of preamble signals from various base stations and choose a target base station that is closest to the user terminal The user terminal may determine or estimate the distance between it and the various base stations based on the relative delay and information from received LBS-ADV messages. In other communication protocols, other reference time signals such as the reference signal time difference (RSTD) signal in Long Term Evolution (LTE) communications may be used.

The above applications may rely on frame synchronous base station communications in which the base stations transmit their preambles at the same time. In such synchronous communications, calculation of time difference is relatively straightforward as the time difference of preamble signals (or start of a communication frame) may be equivalent to the difference of propagation delay from the base station to the user terminal.

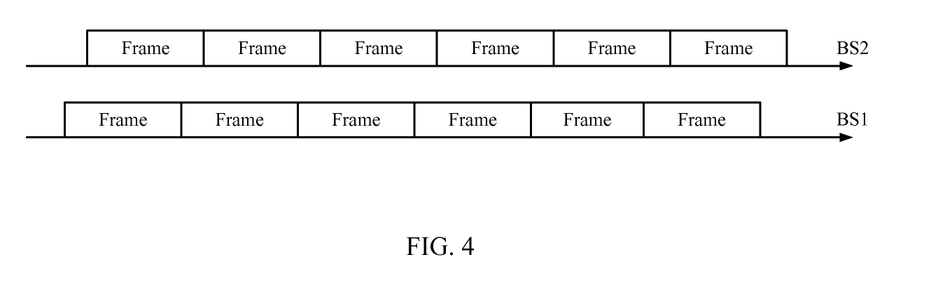

Certain communications, however, may be asynchronous, meaning communication frames are sent by base stations at different times that may not be aligned. An example of asynchronous communications is shown in FIG. 4. In FIG. 4, the frames transmitted from a first base station (BS1) are offset in time from frames transmitted from base station 2 (BS2.) In FIG. 4, the X axis represents time.

During communications with such asynchronous systems, it may be beneficial for a user terminal to measure the time difference between signals transmitted by different base stations and received at the user terminal. Thus, for such asynchronous communications, an improved method is desired to calculate the propagation delay difference based, in part, on measured or estimated time differences associated with preamble signals transmitted from different base stations. Offered is such an improved method to calculate the difference of base station to user terminal propagation delays between frame asynchronous base stations. As used herein, unless stated otherwise, the phrase “time difference” may mean the difference in time between the transmission of signal frames by a base station and/or the arrival of signal frames at a mobile station.

In particular, a method is offered where a user terminal, receiving signals from the base stations, may calculate the difference in frame transmit times between base stations by using a time reference, such as a time from a global positioning system (GPS), virtual GPS time, or a network time protocol, to compare frame transmission times from the base stations to determine a time difference between frame boundaries in signals received from the base stations. To compare frame transmission times, a frame reference may be used, where the reference is the same in each communication signal. For example, the frame reference may be a frame boundary, preamble, or other reference. Specifically the user terminal may measure the time difference of arrival at the user terminal of preamble signals, or frame boundaries, associated with different base stations. The time difference and transmission times may then be used to determine a propagation time difference. The propagation time difference indicates the difference between the time it takes a signal transmitted from a first base station to reach a user terminal and the time it takes a signal transmitted from a second base station to reach the user terminal That propagation time difference may then be used for handover procedures or for location-based services.

The propagation delay from a first base station (BS1) to a user terminal/mobile station (MS) is denoted by τ1. The propagation delay from a second base station (BS2) to the mobile station is denoted by τ2. Therefore, the difference in the propagation delay τ is the difference between τ2 and τ1, namely τ=τ2−τ1.

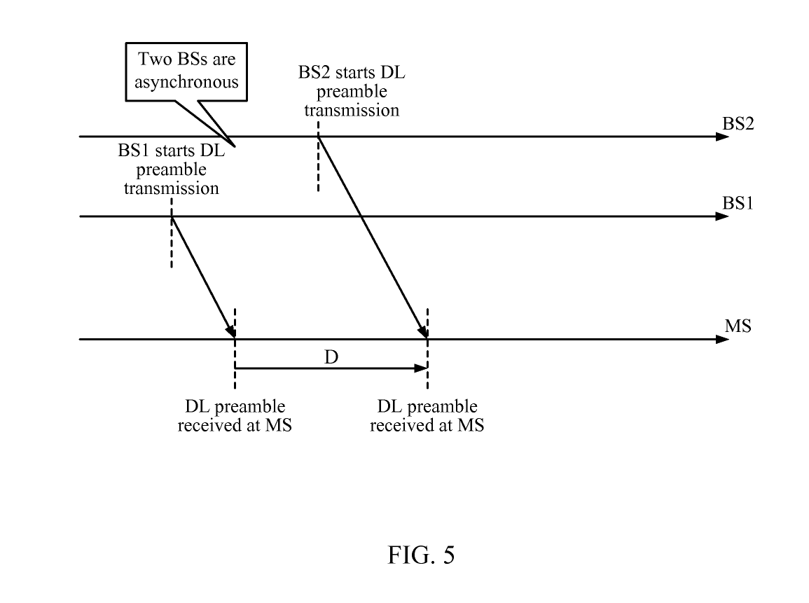

As shown in FIG. 5, to determine τ, initially the mobile station acquires the preambles of the signals transmitted from the two base stations and checks the time differences between when those preambles are received. The delay D represents the difference in receive time between the preamble of the signal of base station 1 and the preamble of the signal of base station 2.

Next, the mobile station parses time data from the LBS-ADV messages sent by the two base stations. GPS time in the LBS-ADV message is expressed in GPS Time TLV (type/length/value) format. GPS time may indicate the start of the first frame of the current epoch (epochs are groups of communication frames starting at frame number 0). In WiMAX, base stations may indicate the time of transmission of frame number 0. The GPS Time TLV uses 12 bits to signal GPS seconds modulo 2048, and 28 bits to represent the GPS fraction second. Because frames are in the order of milliseconds (5 ms for WiMAX, 5 or 10 ms for LTE, etc.), the GPS second fraction information may be more useful for determining frame boundaries than the GPS second information. In other networks, signals that identify signal transmit times, such as System Information Block Type 8 (SIB8) in an LTE network, may be used.

The mobile station acquires the GPS second fraction from the LBS-ADV messages of both base stations. The second fraction of base station 1 is denoted by N1. The second fraction of base station 2 is denoted by N2. The second fraction of base station 2 may be included in the LBS-ADV message transmitted by base station 1. If not, it may be obtained from other LBS-ADV messages (such as those transmitted by base station 2 or another different base station). The GPS second fraction may then be converted into milliseconds using the following equations, where T1 is the second fraction of base station 1 in milliseconds and T2 is the second fraction of base station 2 in milliseconds:

$$\begin{matrix}T 1 = \frac{1000 * N 1}{{2}^{28}} & ( Equation 1 a ) \\ T 2 = \frac{1000 * N 2}{{2}^{28}} & ( Equation 1 b )\end{matrix}$$

Next, the mobile station may assume that both base stations have the same frame duration in milliseconds, denoted by Frame_Duration, and that one second will have an integer number of communication frames. This will allow the calculation of propagation delay to ignore the GPS second value in the GPS Time TLV and consider only GPS second fraction because it is known that a frame boundary will occur between each second.

Next, the time delay between the time each base station begins downlink transmission relative to a GPS virtual frame (which are aligned at the boundary of the GPS second) is determined for each base station as follows:

R1=Remainder(T1, Frame_Duration) (Equation 2a)

R2=Remainder(T2, Frame_Duration) (Equation 2b)

The above function Remainder(x,y) is the remainder for x divided by y. For example, if T1=172.38 ms and Frame_Duration=5 ms, then Remainder(172.38, 5)=2.38 ms.

In the next step, the time difference (E) of the base stations starting downlink transmission time is calculated as follows:

E=R2−R1, if R2≧R1; (Equation 3a)

E=R2−R1+Frame_Duration, if R2<R1. (Equation 3b)

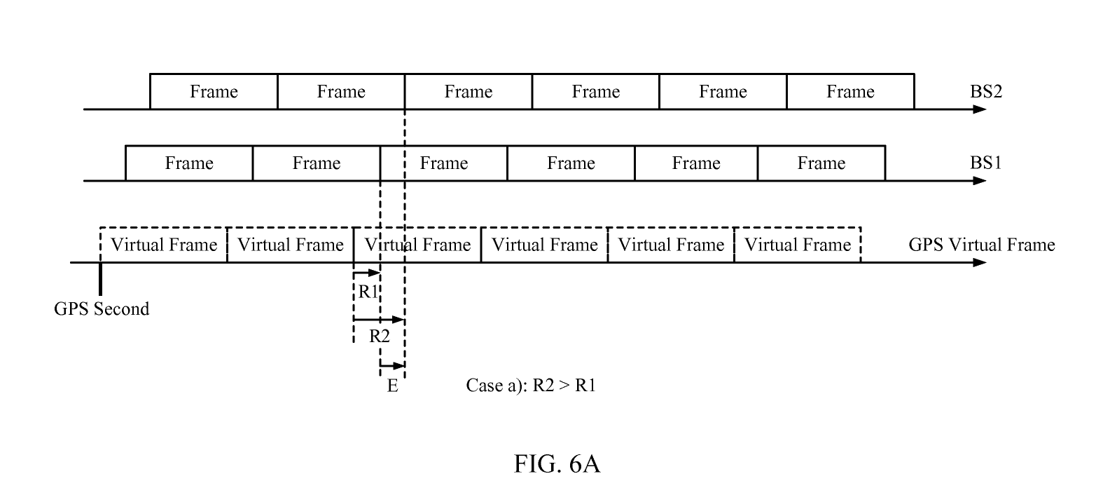

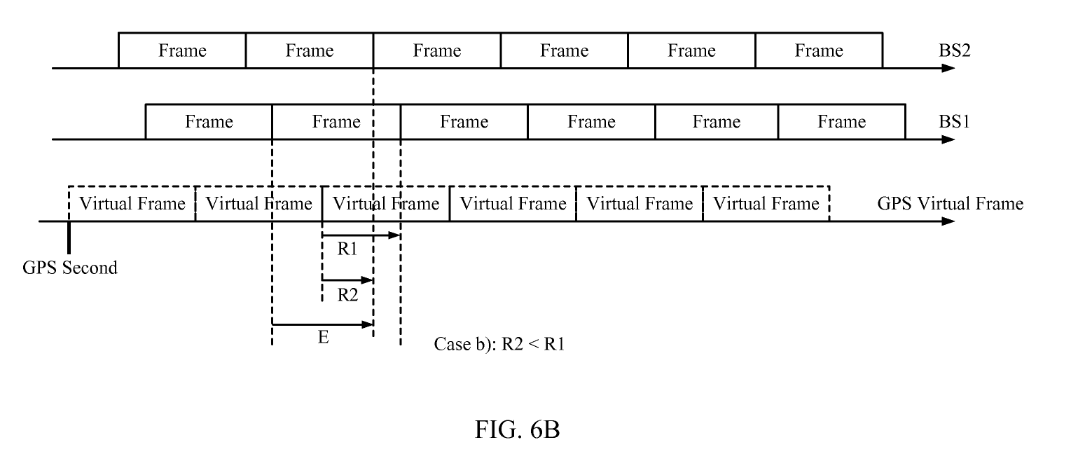

The value E is defined to be non-negative in order to create only one calculation in E that assumes the second base station (BS2) trails the first base station (BS1) in their relative frames. FIG. 6A shows the calculation of E in the case of Equation 3a. FIG. 6B shows the calculation of E in the case of Equation 3b.

The propagation delay time difference τ may then be calculated as follows:

τ=τ2−τ1=D−E, if |D−E|≦A (Equation 4a)

τ=τ2−τ1=D−E−Frame_Duration, if D−E>A (Equation 4b)

τ=τ2−τ1=D−E+Frame_Duration, if D−E<−A (Equation 4c)

where the parameter A is set to a fraction of a frame duration to assist the calculation of τ. For example, A may equal one half of a frame. A may also be >0 to avoid a large absolute value of (D−E), which would imply the frame comparison for the base stations in the initial step above is offset by a full frame as compared to the frame comparison in the later step. E is the difference between the transmission times of the signal frames from the two base stations. D is the difference between the time the signal frames of the two base stations were received by the mobile station. The difference between D and E is caused by the difference in propagation delay, τ.

With the value of the propagation delay known, the mobile station may more accurately determine its position for purposes of using location-based services or performing handover procedures. For example, the mobile station may request a handover to a closest base station.

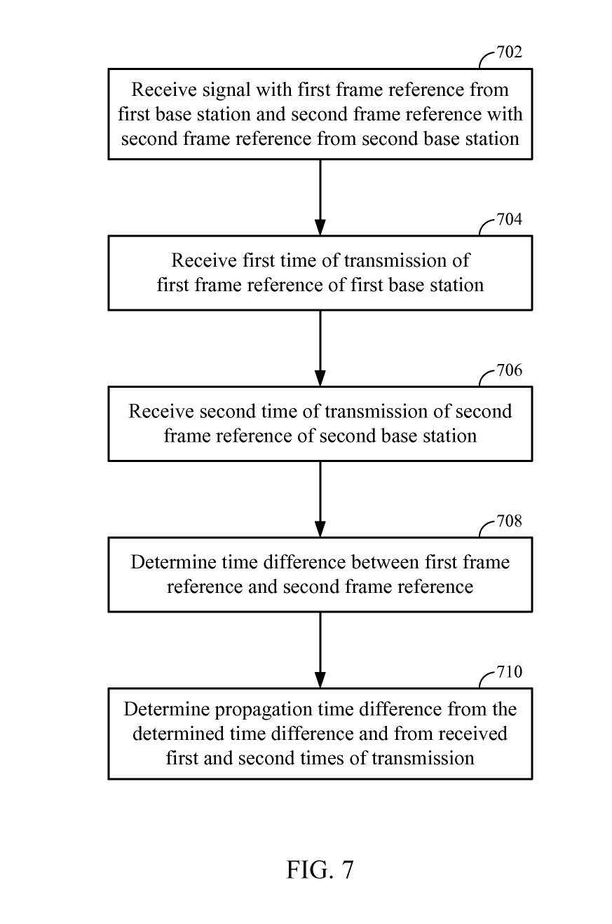

FIG. 7 illustrates a method of determining a downlink time difference according to one aspect of the present disclosure. In block 702 a user terminal receives a first signal with a first frame reference from a first base station and a second signal with a second frame reference from a second base station. In block 704 a user terminal receives a first time of transmission of a first frame reference of a first base station. In block 706 the user terminal receives a second time of transmission of a second frame reference of a second base station. In block 708 the user terminal determines a time difference between the first frame reference and the second frame reference. In block 710 the user terminal determines a propagation time difference from the determined time difference and from the received first and second times of transmission.

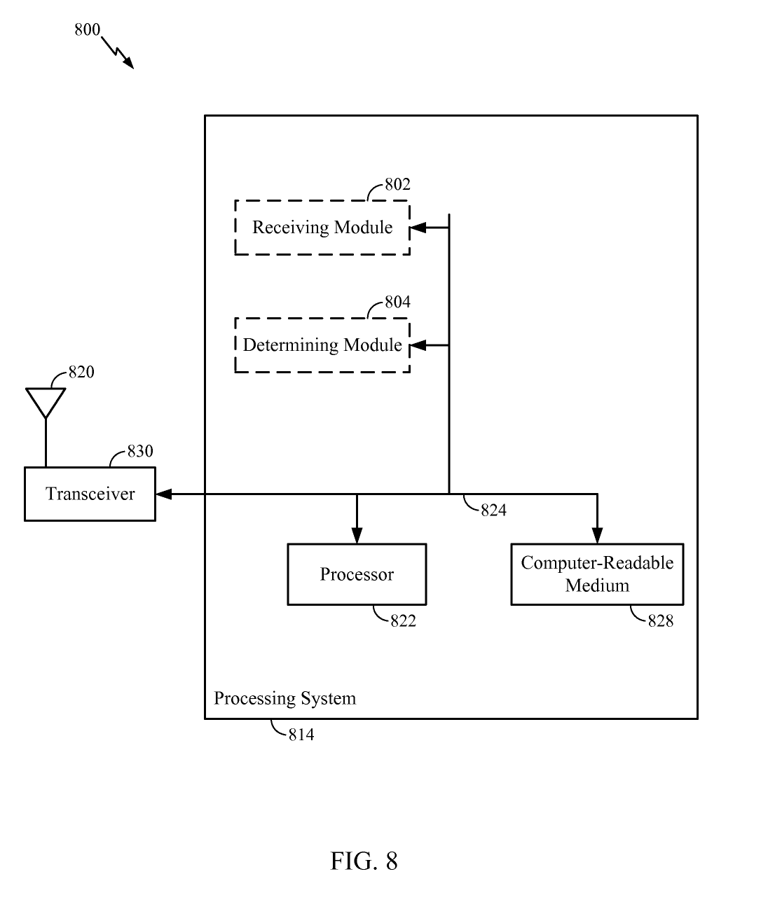

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, and the computer-readable medium 828. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 828. The processor 822 is responsible for general processing, including the execution of software stored on the computer-readable medium 828. The software, when executed by the processor 822, causes the processing system 814 to perform the various functions described for any particular apparatus. The computer-readable medium 828 may also be used for storing data that is manipulated by the processor 822 when executing software.

The processing system 814 includes a receiving module 802 for receiving a first signal with a first frame reference having a first time of transmission from a first base station, a second signal with a second frame reference having a second time of transmission from a second base station. The processing system 814 includes a determining module 804 for determining a time difference between the first frame reference and the second frame reference and for determining a propagation time difference from the determined time difference and from the received first and second times of transmission. The modules may be software modules running in the processor 822, resident/stored in the computer-readable medium 828, one or more hardware modules coupled to the processor 822, or some combination thereof. The processing system 814 may be a component of the user terminal 106 and may include the memory 292, and/or the controller/processor 290.

In one configuration, an apparatus such as a user terminal 106 is configured for wireless communication including means for receiving. In one aspect, the above means may be the antenna 252/820, the receiver 254, the transceiver 830, the receive frame processor 260, and/or the receive processor 270, receiving module 802 and/or the processing system 814 configured to perform the functions recited by the aforementioned means. In another aspect, the aforementioned means may be a module or any apparatus configured to perform the functions recited by the aforementioned means.

In one configuration, the user terminal is configured for wireless communication including means for determining. In one aspect, the above means may be the receive frame processor 260, the receive processor 270, the transceiver 830, the memory 292, the controller/processor 290, the processor 822, the computer-readable medium 828, and/or the processing system 814 configured to perform the functions recited by the means. In another aspect, the aforementioned means may be a module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
receiving a first signal transmitted from a first base station and a second signal transmitted from a second base station, the first signal having a first frame reference, and the second signal having a second frame reference;
receiving a first time of transmission of the first frame reference of the first base station;
receiving a second time of transmission of the second frame reference of the second base station;
determining a reception time difference between the first frame reference and the second frame reference; and
determining a propagation time difference from the determined reception time difference and from the received first and second times of transmission.

2. The method of claim 1, in which the first and second times of transmission are determined from a timing reference.

3. The method of claim 2, in which the timing reference is one of a GPS time, virtual GPS time, and a network time protocol.

4. The method of claim 1, in which the propagation time difference is at least one of a propagation time difference for a handover procedure or a location based service.

5. The method of claim 1, in which the first frame reference is determined from a preamble signal from the first base station and the second frame reference is determined from a preamble signal from the second base station.

6. The method of claim 1, in which the first frame reference is determined from a frame boundary from the first base station and the second frame reference is determined from a frame boundary from the second base station.

7. An apparatus for wireless communication, comprising:
means for receiving a first signal transmitted from a first base station and a second signal transmitted from a second base station, the first signal having a first frame reference, and the second signal having a second frame reference;
means for receiving a first time of transmission of the first frame reference of the first base station;
means for receiving a second time of transmission of the second frame reference of the second base station;
means for determining a reception time difference between the first frame reference and the second frame reference; and
means for determining a propagation time difference from the determined reception time difference and from the received first and second times of transmission.

8. The apparatus of claim 7, further comprising means for determining the first and second times of transmission from a timing reference.

9. The apparatus of claim 7, further comprising means for determining the first frame reference from a preamble signal from the first base station and the second frame reference from a preamble signal from the second base station.

10. The apparatus of claim 7, further comprising means for determining the first frame reference from a frame boundary from the first base station and the second frame reference from a frame boundary from the second base station.

11. A computer program product for wireless communications in a wireless network, comprising:
a computer-readable medium having non-transitory program code recorded thereon, the program code comprising:
program code to receive a first signal transmitted from a first base station and a second signal transmitted from a second base station, the first signal having a first frame reference, and the second signal having a second frame reference;
program code to receive a first time of transmission of the first frame reference of the first base station;
program code to receive a second time of transmission of the second frame reference of the second base station;
program code to determine a reception time difference between the first frame reference and the second frame reference; and
program code to determine a propagation time difference from the determined reception time difference and from the received first and second times of transmission.

12. The computer program product of claim 11, in which the program code further comprises program code to determine the first and second times of transmission from a timing reference.

13. The computer program product of claim 11, in which the program code further comprises program code to determine the first frame reference from a preamble signal from the first base station and the second frame reference from a preamble signal from the second base station.

14. The computer program product of claim 11, in which the program code further comprises program code to determine a frame boundary from the first base station and the second frame reference from a frame boundary from the second base station.

15. An apparatus for wireless communication, comprising:
a memory; and
at least one processor coupled to the memory and configured:
to receive a first signal transmitted from a first base station and a second signal transmitted from a second base station, the first signal having a first frame reference, and the second signal having a second frame reference;
to receive a first time of transmission of the first frame reference of the first base station;
to receive a second time of transmission of the second frame reference of the second base station;
to determine a reception time difference between the first frame reference and the second frame reference; and
to determine a propagation time difference from the determined reception time difference and from the received first and second times of transmission.

16. The apparatus of claim 15, in which the at least one processor is further configured to determine first and second times of transmission from a timing reference.

17. The apparatus of claim 16, in which the timing reference is one of a GPS time, virtual GPS time, and a network time protocol.

18. The apparatus of claim 15, in which the propagation time difference is at least one of a propagation time difference for a handover procedure or a location based service.

19. The apparatus of claim 15, in which the at least one processor is further configured to determine the first frame reference from a preamble signal from the first base station and the second frame reference from a preamble signal from the second base station.

20. The apparatus of claim 15, in which the at least one processor is further configured to determine the first frame reference from a frame boundary from the first base station and the second frame reference from a frame boundary from the second base station.
